(19) United States
(12) Patent Application Publication
(10) Pub. No.: US 2013/0022300 A1
(43) Pub. Date: Jan. 24, 2013

(54) SHAFT SUPPORT STRUCTURE

(71) Applicant: Mitsuru Fukumoto, Utsunomiya-shi (JP)

(72) Inventor: Mitsuru Fukumoto, Utsunomiya-shi (JP)

(73) Assignee: NIFCO INC., Yokohama-shi, Kanagawa (JP)

(21) Appl. No.: 13/582,286

(22) PCT Filed: Feb. 24, 2011
(86) PCT No.: PCT/JP2011/001065

§ 371 Date: Sep. 13, 2012

(30) Foreign Application Priority Data
Mar. 4, 2010 (JP) 2010-048265

(51) Int. Cl. F16C 11/04

(52) U.S. Cl. 384/154

(57) ABSTRACT

A shaft support structure for supporting molded articles, a rotating member and a shaft-bearing member, in which a rotating shaft provided on a rotating member is supported in a pair of shaft-bearing openings provided on the shaft-bearing member. The rotating shaft has a held part held in the shaft-bearing opening and has a plurality of outer-perimeter edge parts arranged at a maximal distance from a center of rotation. The shaft-bearing opening has a plurality of inner-perimeter edge parts arranged correspondingly with the outer-perimeter edge parts. A distance from the center of rotation to the outer-perimeter edge parts and a distance from the center of rotation to the inner-perimeter edge parts are the same when the rotating shaft is held, and one part between the outer-perimeter edge parts and the inner-perimeter edge parts is in mutual sliding contact only when the rotating shaft is within a prescribed range of rotation.

### TECHNOLOGICAL FIELD

The present invention relates to a shaft support structure in two members, which are molded articles made from synthetic resin, or the like, for supporting both sides of a rotating shaft provided on one member in a pair of shaft-bearing openings provided on the other member.

### BACKGROUND TECHNOLOGY

There is conventionally known, as an example of this kind of shaft supporting structure, an optical device having a connection plate having a shaft-bearing part and a rack having a rotating shaft, wherein two shaft-bearing openings are provided on the shaft-bearing part, at least one being constituted as a cutout hole, and a D-cut part to be inserted into the cutout hole is formed on an outer perimeter surface of the rotating shaft, whereby elimination of rattling in a thrust direction and in a radial direction is devised (see Patent Document 1).

Also, there is known, for example, one relating to a shaft support structure in a loop clutch made of synthetic resin, wherein a loop clutch body and a belt installation body are integrally molded simultaneously in one step, in a state in which a rotating shaft provided on the loop clutch body is inserted with play into a shaft-bearing opening provided on the belt installation body (see Patent Document 2).

### PRIOR ART DOCUMENTS

### Patent Documents

Patent Document 1: Japanese Unexamined Patent Publication No. H5-187431

Patent Document 2: Japanese Examined Patent Publication No. H6-74802

### SUMMARY OF THE INVENTION

### Problems to be Solved by the Invention

However, in the prior art described in the abovementioned Patent Document 1, the external dimensions of the rotating shaft are set to be roughly equal to the internal dimensions of the shaft-bearing opening, and there is a problem that the two members (rack and connection plate) must be molded separately because a space in the mold during molding cannot be assured in a state in which the two members have been assembled (that is, a state in which the rotating shaft has been inserted in the shaft-bearing opening).

Also, in the prior art described in the abovementioned Patent Document 2, because the shaft-bearing structure is such that the rotating shaft is inserted with play in the shaft-bearing opening, a space in the mold can be assured, but there is a problem that rotational movement with good precision cannot be expected and the uses become limited.

The present invention is proposed in consideration of the problems of such conventional technology, and an object thereof is to provide a shaft support structure in a case when a rotating shaft provided on one of two members constituted by molded articles is supported in a pair of shaft-bearing openings provided on the other, wherein the precision of rotational movement can be assured to be good and simultaneous molding of the two members in the same mold is made possible.

### Means for Solving the Problems

According to a first aspect of the present invention, which was created in order to solve the abovementioned problems, a shaft support structure, relating to a rotating member (11) and shaft-bearing members (12, 13), which are molded articles, for supporting rotating shafts (24, 25) provided on the rotating member in a pair of shaft-bearing openings (32, 36) provided on the shaft-bearing member, wherein said rotating shaft has a held part (37) held in at least one shaft-bearing opening (36), said held part has a cross-section of a noncircular shape and a plurality of maximum outer perimeter edge parts (51, 52) arranged at a maximal distance from a center (C) of rotation and spaced apart from each other in a circumferential direction. Said at least one shaft-bearing opening has a noncircular shape and has a plurality of corresponding inner perimeter edge parts (53, 54) arranged in correspondence with said maximum outer perimeter edge parts. A distance from said center of rotation to said maximum outer perimeter edge parts and a distance from said center of rotation to said corresponding inner perimeter edge parts are the same in a state in which said rotating shaft is held in said at least one shaft-bearing opening, and at least one part between said maximum outer perimeter edge parts and said corresponding inner perimeter edge parts is in mutual sliding contact only in a case when said rotating shaft is within a prescribed range of rotation.

Also, according to a second aspect of the present invention, said maximum outer perimeter edge parts and said corresponding inner perimeter edge parts have arc forms having the same curvature as each other.

Also, according to a third aspect of the present invention, each of said maximum outer perimeter edge parts respectively is arranged in symmetric positions based on said center of rotation in a state in which each is spaced apart from each other in the circumferential direction; and said corresponding inner perimeter edge parts are arranged in plural in correspondence with the positions of said maximum outer perimeter edge parts.

Also, according to a fourth aspect of the present invention, said rotating shaft has an expanded-diameter part (29) formed adjacent to said held part in an axial direction of the shaft and in a position toward the side of the other end than the held part, and the expanded-diameter part projects outwardly from said held part than said maximum outer perimeter edge part in a diameter direction.

Also, according to a fifth aspect of the present invention, said rotating member has a coupling part (26) engageable with said shaft-bearing member; and said shaft-bearing member has a corresponding coupling part (38) for restricting rotational movement of the rotating member within said prescribed range of rotation by coupling with said coupling part.

Also, according to a sixth aspect of the present invention, said rotating member and said shaft member can be pre-assembled e in a state in which said rotating shaft is held in said at least one shaft-bearing opening.

### Effects of the Invention

According to the abovementioned first aspect of the present invention, in a structure relating to two members (a rotating member and a shaft-bearing member) which are molded articles, for supporting both sides of a rotating shaft provided on one (the rotating member) in a pair of shaft-bearing openings provided on the other (the shaft-bearing member): at least one part between the maximum outer perimeter edge parts and the corresponding inner perimeter edge parts is in mutual sliding contact only in the case when the rotating shaft is within a prescribed range of rotation; meanwhile, a gap arises between the outer perimeter edge of the rotating shaft and the inner perimeter edge of the shaft-bearing opening in the case when the rotating shaft is outside the prescribed range of rotation. Accordingly, there are excellent effects that, while the rotational movement of the rotating member can be assured to be good by rotating the rotating shaft within the prescribed range of rotation, the two members can be molded simultaneously in the same mold by performing molding in a state in which the rotating shaft is outside the prescribed range of rotation.

Also, according to the abovementioned second aspect of the present invention, the structures of the rotating shaft and the shaft-bearing opening are simplified, and the rotating shaft can be rotated with higher precision within the prescribed range of rotation.

Also, according to the abovementioned third aspect of the present invention, the structures of the rotating shaft and the shaft-bearing openings are simplified, and the range of rotation in which the precision of rotational movement of the rotating shaft can be assured to be good can be assured more widely.

Also, according to the abovementioned fourth aspect of the present invention, movement (rattling) of the rotating shaft in the axial direction can be restricted by contacting the expanded-diameter part to the end face of the shaft-bearing opening.

Also, according to the abovementioned fifth aspect of the present invention, rotational movement of the rotating shaft is assuredly limited to within the prescribed range of rotation, and the precision of the rotational movement can be assured to be good.

Also, according to the abovementioned sixth aspect of the present invention, molding can be performed easily in the state in which the rotating shaft is outside the prescribed range of rotation, and the operation of assembly after molding is simplified.

### BRIEF DESCRIPTION OF THE DRAWINGS

FIG. 1 is a partially exploded perspective view of a cup holder having the shaft support structure according to a first embodiment.

FIG. 2 is a diagram illustrating the periphery of the container-holding mechanism of the cup holder according to the first embodiment.

FIGS. 3(A), 3(B) are perspective views of the flap member according to the first embodiment.

FIG. 4 is a perspective view illustrating the shaft-bearing member according to the first embodiment.

FIGS. 5(A), 5(B) are diagrams for describing the operation of the flap member according to the first embodiment.

FIG. 6 is a perspective view illustrating the state of rotation of the flap during rotation (during receiving of a beverage container) in the cup holder according to the first embodiment.

FIG. 7 is a side view illustrating the state of the essential parts during molding of the cup holder according to the first embodiment.

FIG. 8 is a perspective view illustrating the state of the essential parts during molding of the cup holder according to the first embodiment.

FIG. 9 is a perspective view of the essential parts of the cup holder according to the second embodiment.

FIG. 10 is a front view of the essential parts of the cup holder according to the second embodiment.

FIG. 11 is a diagram illustrating the periphery of the container-holding mechanism of the flap member according to a second embodiment.

### EMBODIMENTS OF THE INVENTION

Examples in which the shaft support structure according to the present invention is applied to a cup holder are described below while referring to the drawings. This cup holder can be placed, for example, in a center console box provided between the driver's seat and the front passenger seat of a passenger car.

### First Embodiment

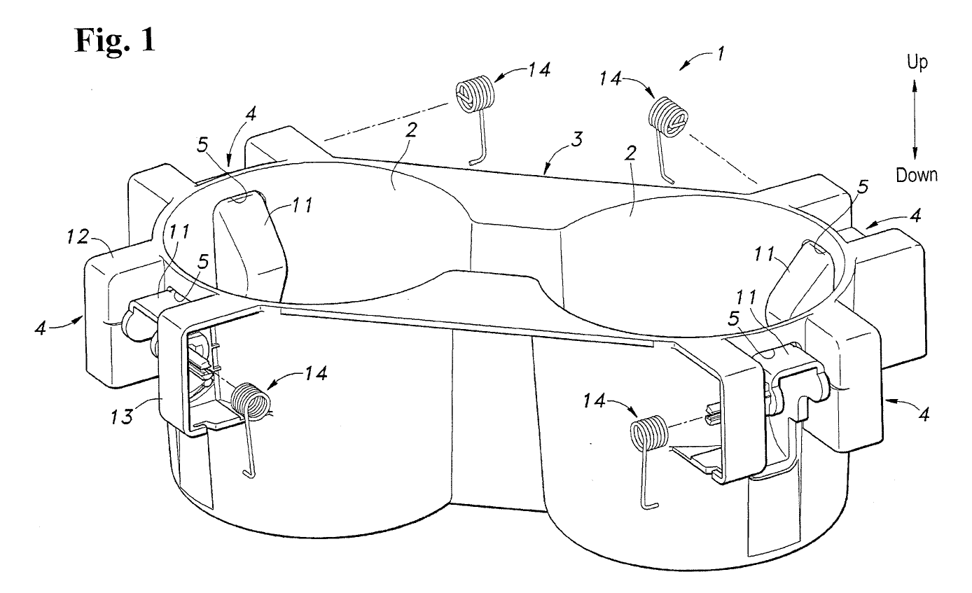

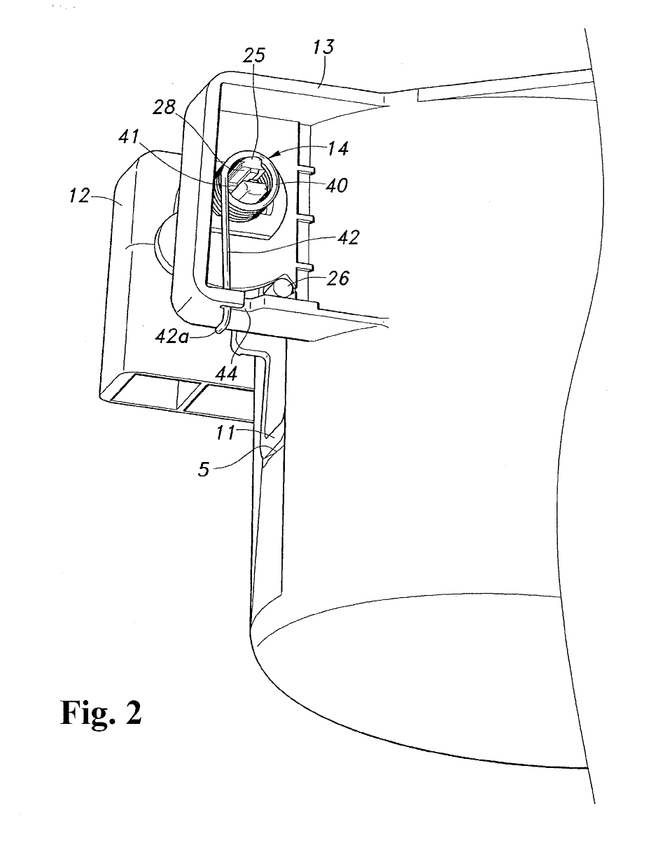

As illustrated in FIGS. 1 and 2, the cup holder 1 according to the first embodiment mainly comprises a holder body 3 made of synthetic resin, having two container-receiving parts 2 placed in parallel, and two pairs of (four) container-holding mechanisms 4, being provided in correspondence with each container-receiving part 2. The container-receiving part 2 has a cylindrical form with a bottom, and is capable of receiving a beverage can, PET bottle, or other container being inserted from the upper opening. Here, each container-holding mechanism 4 has the same structure or a left-right symmetrical structure, setting aside that the arrangements are mutually different, and the details are described below without distinguishing them.

The container-holding mechanisms 4 are arranged on a perimeter wall outside the container-receiving part 2 (on the side away from the other container-receiving part 2). The container-holding mechanism 4 has: a flap 11 made of synthetic resin, being provided to move in and out freely from an opening 5 on the container-receiving part 2, and pressing the beverage can, or the like (not illustrated) toward the perimeter wall inside the container-receiving part 2; a pair of shaft-bearing members 12 and 13, projecting sideways from the holder body 3 so as to confront each other, and supporting the flap 11 to rotate freely; and a torsion coil spring 14 made of metal, for urging the flap 11 toward the inside of the container-receiving part 2.

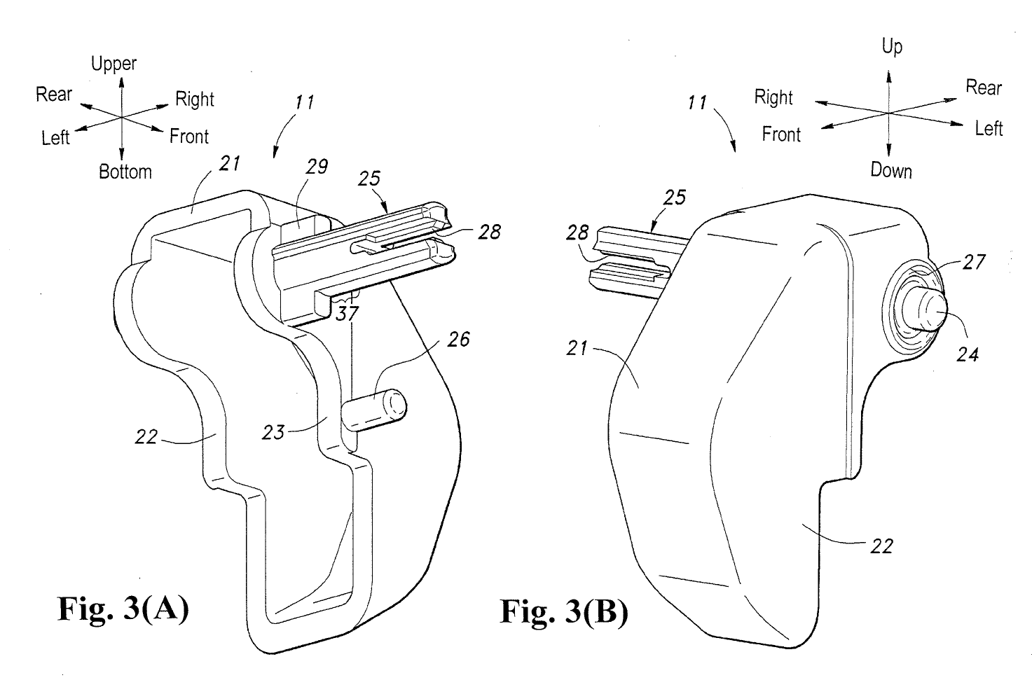

The flap 11, as illustrated in FIGS. 3(A), 3(B), has a bucket-like shape, having: a convex curved bottom wall 21, being capable of contacting with the perimeter surface of the beverage container, or the like; and left and right side walls 22 and 23, respectively being connected to both side edges of the bottom wall 21, and being arranged in parallel with each other. A pair of rotating shafts 24 and 25 left and right, being arranged on the same axis as each other, is placed projecting respectively toward the left and right from upper parts of the left side wall 22 and right side wall 23. Also, a rotation-restricting pin 26 is placed projecting in parallel with the right rotating shaft 25 in a middle part in the vertical direction of the right side wall 23.

The left rotating shaft 24 has a round-columnar form, and an annular raised part 27, for contacting with the left shaft-bearing member 12 (first support wall 31) and preventing rattling of the flap 11, is formed on the periphery thereof. Also, the right rotating shaft 25 has a vertically long noncircular cross-section, and a slit 28 is formed to be cut in from a leading end toward a base end of the right rotating shaft so as to divide the right rotating shaft 25 vertically. Also, an expanded-diameter part 29, having an expanded diameter in a diameter direction (vertical direction) thereof, is provided on the base end side of the right rotating shaft 25. The right rotating shaft 25, excluding the expanded-diameter part 29, has the same external shape (tapered external shape) as that of a held part 37 to be described in detail, or smaller on the leading end side thereof.

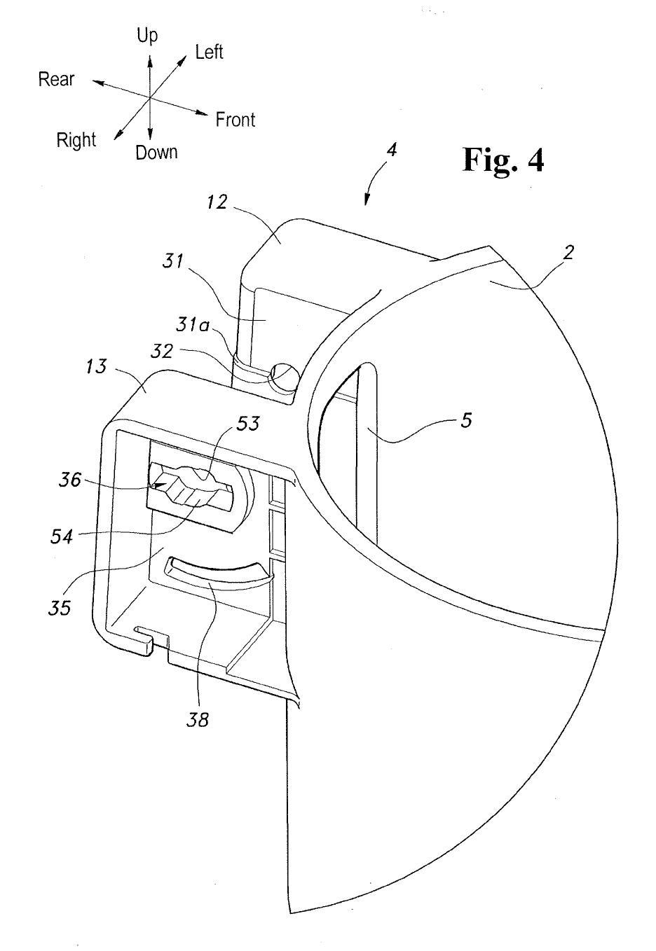

The left shaft-bearing member 12 has a roughly parallelepiped form having an open lower face, and has a first support wall 31, being a vertical wall, extending in the vertical direction on the inside (right shaft-bearing member 13 side) thereof as illustrated in FIG. 4. A left shaft-bearing opening 32, in which the left rotating shaft 24 (see FIGS. 3(A), 3(B)) of the flap 11 is inserted, is formed on the first support wall 31. The left shaft-bearing opening 32 has an inner diameter being roughly the same as an outer diameter of the left rotating shaft 24. Also, the first support wall 31 has a step 31a projecting out on a lower side from the center of the left shaft-bearing opening 32, whereby insertion of the left rotating shaft 24 into the left shaft-bearing opening 32 is made easier.

Also, the right shaft-bearing member 13 has a roughly parallelepiped form having an open right face, and has a second support wall 35 facing opposite the first support wall 31 of the left shaft-bearing member 12. A right shaft-bearing opening 36, in which the right rotating shaft 25 of the flap 11 is inserted, is formed on the second support wall 35. The right shaft-bearing opening 36 is a noncircular long hole extending in the left to right direction, and a state of holding of the right rotating shaft 25 is changed in accordance with a rotational position of the flap 11 (right rotating shaft 25), as is to be described. The right shaft-bearing opening 36 is formed on a thickened part on the second support wall 35, and a held part 37 (see FIGS. 3(A), 3(B)), being positioned between the leading end of the slit 28 and the expanded-diameter part 29, is held on the right rotating shaft 25. Also, a downwardly convex arc-form rotation-restricting hole 38 is formed below the right shaft-bearing opening 36 on the second support wall 35. The rotation-restricting pin 26 (see FIGS. 3(A), 3(B)) of the flap 11 is inserted in the rotation-restricting hole 38.

A torsion coil spring 14 is bent in a manner so that an arm 41 on one side of a coil part 40 crosses the center thereof, and a linear arm 42 is placed extending from the other side of the coil part 40, as illustrated in FIG. 2. The right rotating shaft 25 is inserted into the coil part 40 of the torsion coil spring 14, and the arm 41 is held in the slit 28. Also, a bent leading end part 42a of the arm 42 is locked in a state being inserted into an L-form slit 44 being formed on a bottom wall 43 of the right shaft-bearing member 13.

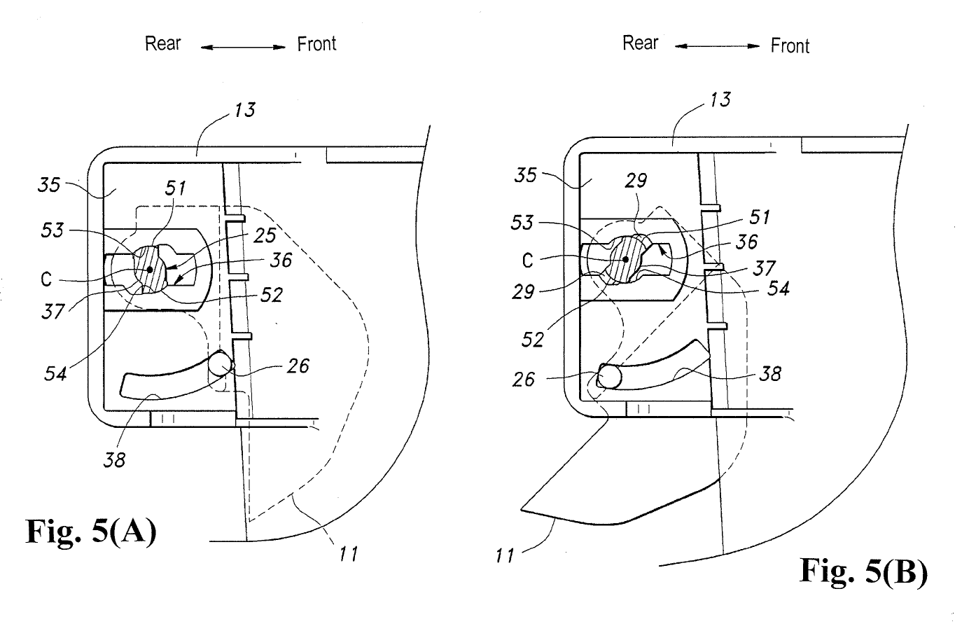

The flap 11 is urged by the torsion coil spring 14 toward the inside of the container-receiving part 2, and is held in an initial state illustrated in FIG. 5(A). At this time, the rotation-restricting pin 26 of the flap 11 contacts with a front end of the rotation-restricting hole 38, whereby a rotational limit (maximally advanced position) of the flap 11 toward the side of advancement is prescribed.

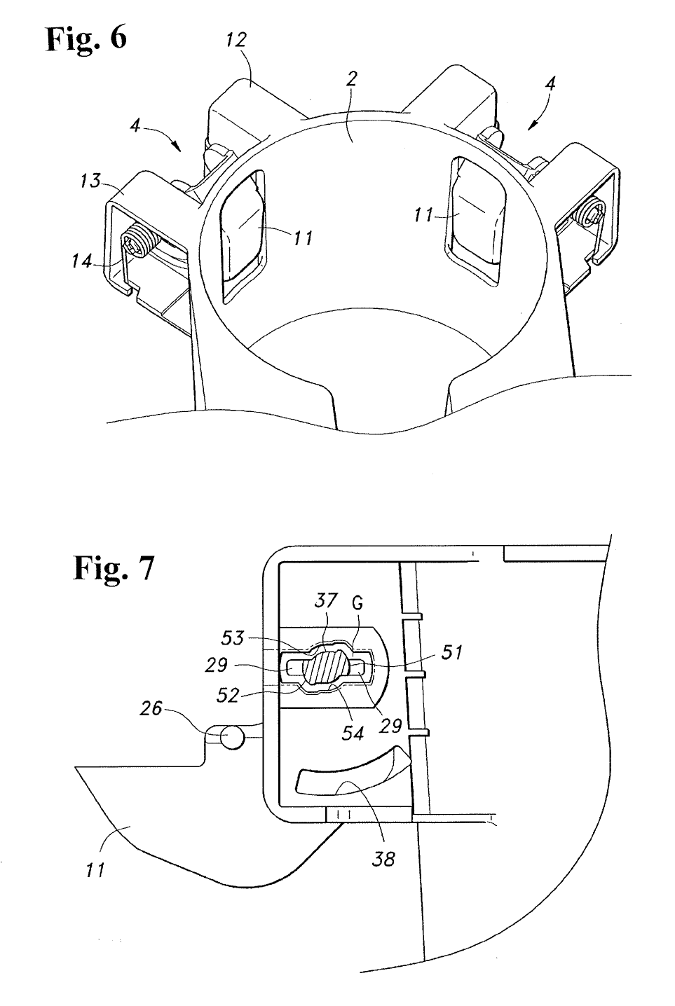

Meanwhile, when a beverage can, or the like, is inserted in the container-receiving part 2, the flap 11 is pressed and retracts toward the outside of the container-receiving part 2 in opposition to the urging force of the torsion coil spring 14, as illustrated in FIGS. 5(B) and 6. At this time, the rotation-restricting pin 26 of the flap 11 contacts with a rear end of the rotation-restricting hole 38, whereby a rotational limit (maximally retracted position) toward the side of retraction of the flap 11 is prescribed.

As illustrated in FIGS. 5(A), 5(B), the right rotating shaft 25 has arc parts on both end edges in the long direction of the held part 37, which has a vertically long cross-section. More specifically, the right rotating shaft 25 is such that at least the cross-section of the held part, which is held in the right shaft-bearing opening 36, has two arc-form maximum outer perimeter edge parts 51 and 52, which are outer perimeter edge parts, and are arranged at a maximal distance from the center C of rotation and spaced apart from each other in the circumferential direction. Also, the long-hole-form right shaft-bearing opening 36 has arc parts on both end edges in the short direction thereof. More specifically, the right shaft-bearing opening 36 has two arc-form minimum perimeter edge parts 53 and 54, which are inner perimeter edge parts, and are respectively arranged at a minimal distance from the center C of rotation in a state holding the right rotating shaft 25 and in correspondence with the positions of the maximum outer perimeter edge parts 51 and 52.

By such shaft support structure, in the state in which the right rotating shaft 25 is held in the right shaft-bearing opening 36, a distance from the center C of rotation to the maximum outer perimeter edge parts 51 and 52 and a distance from the center C of rotation to the minimum inner perimeter edge parts 53 and 54 become substantially the same. In other words, in the case when the right rotating shaft 25 is within the prescribed range of rotation, rattling in the diameter direction of the right rotating shaft 25 (flap 11) is prevented, and the precision of rotational movement can be assured to be good. Here, the prescribed range of rotation in the present embodiment is the range between the rotational position illustrated in FIG. 5(A) and the rotational position illustrated in FIG. 5(B), but more strictly speaking, it is the limit of the rotational position of the right rotating shaft 25, of which at least one part between the maximum outer perimeter edge part 51 and the minimum inner perimeter edge part 53 is in sliding contact, and at least one part between the maximum outer perimeter edge part 52 and the minimum inner perimeter edge part 54 is in sliding contact. In the present embodiment, because the left rotating shaft 24 is inserted into the left shaft-bearing opening 32 without rattling, there is no adverse influence on the precision of rotational movement of the flap 11, regardless of the range of rotation of the right rotating shaft 25.

The maximum outer perimeter edge parts 51 and 52 and the minimum inner perimeter edge parts 53 and 54 can take various forms provided that at least the distances from the center C of rotation are the same. In the present embodiment, the maximum outer perimeter edge parts 51 and 52 and the minimum inner perimeter edge parts 53 and 54 have arc-form shapes having the same curvature as each other, whereby the structures of the right rotating shaft 25 and the right shaft-bearing opening 36 are simplified, and the right rotating shaft 25 can be rotated with higher precision within the prescribed range of rotation.

Also, the maximum outer perimeter edge parts 51 and 52 (the same also with respect to the minimum inner perimeter edge parts 53 and 54) respectively are arranged in symmetric positions based on the center C of rotation in a state being space apart from each other. By this, the range of rotation in which the precision of rotational movement of the right rotating shaft 25 can be assured to be good can be assured more widely. In the present embodiment, an example in which two maximum outer perimeter edge parts 51 and 52 are provided is presented, but the present invention is not limited to this, and the number of maximum outer perimeter edge parts 51 and 52 can be suitably changed (the same goes also with respect to the minimum inner perimeter edge parts 53 and 54). For example, the maximum outer perimeter edge parts 51 and 52 may be configured respectively with a plurality of outer perimeter edge parts having shorter arcs.

Also, an annular raised part 27 having a radius larger than that of the left shaft-bearing opening 32 is formed on the perimeter of the left rotating shaft 24. Meanwhile, the right rotating shaft 25 has an expanded-diameter part 29 projecting further outward than the maximum outer perimeter edge parts 51 and 52 of the held part 37 in the diameter direction. By this, the annular raised part 27 and the expanded-diameter part 29 respectively contact with the end face of the left shaft-bearing opening 32 (front face of first support wall 31) and the end face of the right shaft-bearing opening 36 (front face of second support wall 35), whereby movement of the flap 11 in the axial direction is restricted (that is, rattling in the axial direction between the first support wall 31 and the second support wall 35 is prevented).

Also, by the coupling between the rotation-restricting pin 26 and the rotation-restricting hole 38, rotational movement of the right rotating shaft 25 is assuredly limited to within the prescribed range of rotation, and the precision of the rotational movement can be assured to be good.

In the present embodiment, the rotating shafts of the flap 11 are configured with two rotating shafts (left rotating shaft 24 and right rotating shaft 25), but these can also be configured integrally as one rotating shaft. Also, the left rotating shaft 24 and the left shaft-bearing opening 32 may have the same structure, respectively, as the right rotating shaft 25 and the right shaft-bearing opening 36. Furthermore, the right shaft-bearing opening 36 does not necessarily have to be a closed hole, provided that it has at least the minimum inner perimeter edge parts 53 and 54 as described above. For example, the right shaft-bearing opening may be in a slit form in which at least one part is open, or the like, as indicated by the double-dotted line in FIG. 7,

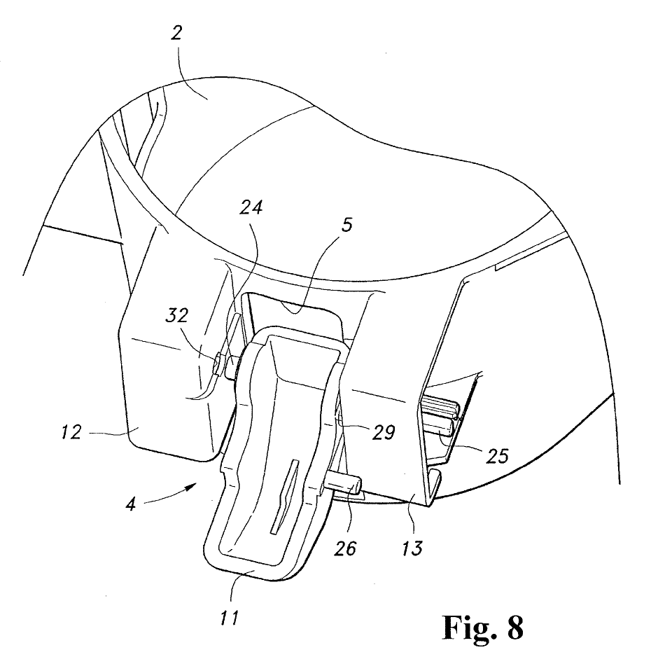

In the cup holder 1 having the above configuration, the left and right shaft-bearing members 12 and 13 (here, integrally formed with the holder body 3) and the flap 11 is produced by injection molding of synthetic resin in a provisionally assembled state in which the right rotating shaft 25 is inserted with play in the right shaft-bearing opening 36, as illustrated in FIGS. 7 and 8. At this time, the left rotating shaft 24 and the rotation-restricting pin 26 respectively are in a state being removed from the left shaft-bearing opening 32 and the rotation-restricting hole 38. Also, the rotational position of the flap 11 (right rotating shaft 25) is outside the above-described prescribed range of rotation, and in the side view illustrated in FIG. 7, a gap G arises at the periphery of the right rotating shaft 25 (at least between the outer perimeter edge of the held part 37 (here, including also the outer perimeter edge of the expanded-diameter part 29) and the inner perimeter edge of the right shaft-bearing opening 36).

By this, in relation to the molds used for injection molding, the holder body 3 and the flap 11 can be simultaneously molded in the same mold, for example, by arranging a stationary mold below the shaft-bearing members 12 and 13, arranging a mobile mold above the shafts, and furthermore arranging a slider that is movable from the right of the right shaft-bearing member 13 in parallel with the right rotating shaft 25. In this case, the right rotating shaft 25 can be molded in a state being spaced apart from the right shaft-bearing opening 36, by inserting the slider in the gap G (in the present embodiment, a gap being formed with a constant size at the periphery of the right rotating shaft 25). Also, because the shaft-bearing members 12 and 13 and the flap 11 after molding are in a provisionally assembled state, it is easy for the operator to assemble the container-holding mechanisms 4.

### Second Embodiment

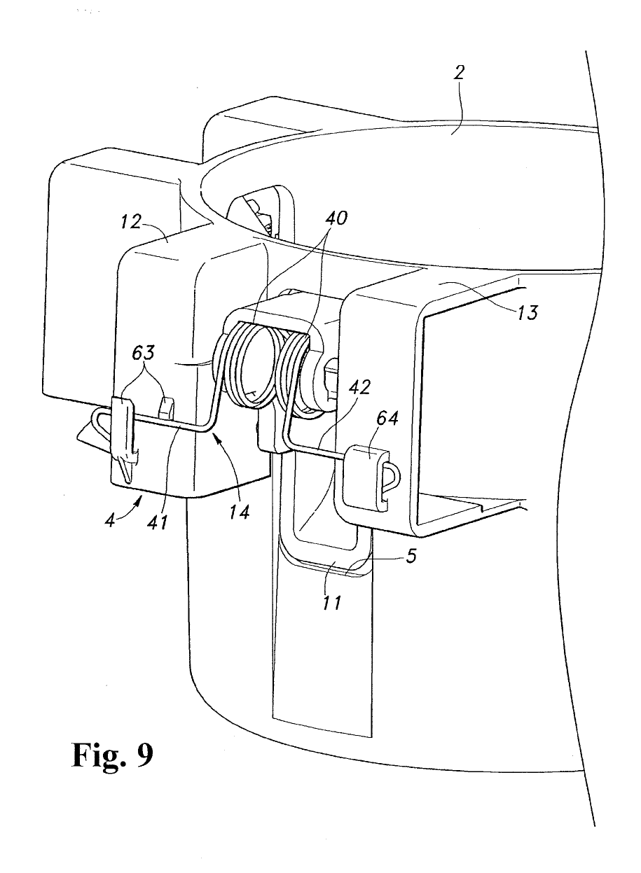

A cup holder according to a second embodiment is next described while referring to FIGS. 9 to 11. In FIGS. 9 to 11, the same symbols are assigned to the same constituent elements as in the first embodiment. Also, in the second embodiment, detailed descriptions are omitted with respect to the same matters as in the first embodiment, except for matters expressly mentioned below.

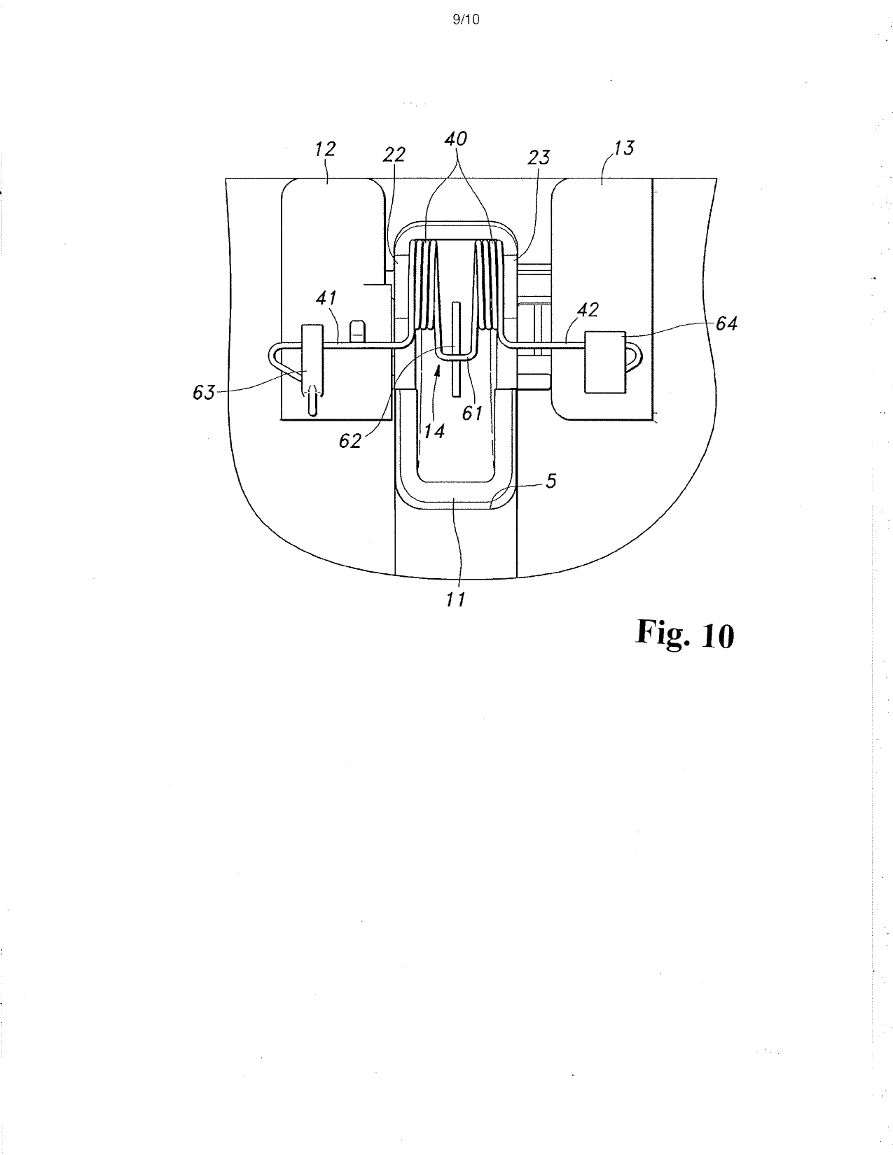

In the cup holder 1 according to the second embodiment, the configuration of the torsion coil spring 14 for urging the flap 11 and the configuration of the right rotating shaft 25 are different from the case of the first embodiment. The torsion coil spring 14 has a double-torsion shape in which two coil parts 40 and 40 are connected in series directly, as illustrated in FIGS. 9 and 10. The two coil parts 40 and 40 of the torsion coil spring 14 are held between the left and right side walls 22 and 23 on the flap 11, and a connection part 61 connecting between the two coil parts 40 and 40 is locked to a locking piece 62 being provided on an inner face of the bottom wall 21 of the flap 11. Also, two arms 41 and 42 of the torsion coil spring 14 are placed to extend in parallel with the axial direction of the coil parts 40, and bent leading end parts thereof are installed in anchoring parts 63 and 64 formed on the left and right shaft-bearing members 12 and 13.

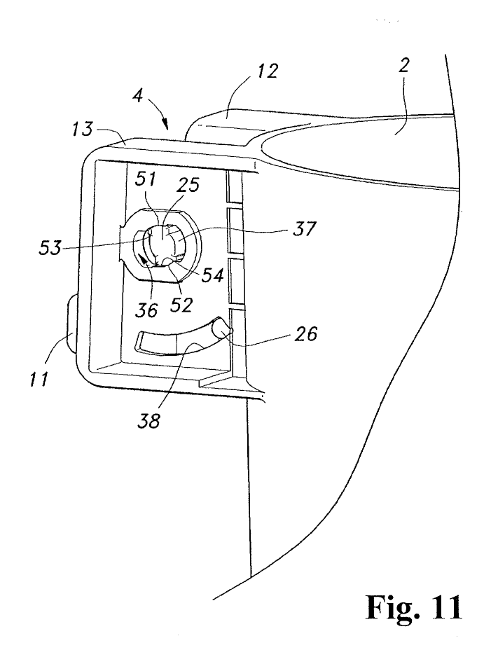

Also, as illustrated in FIG. 11, the right rotating shaft 25 has the same kind of held part 37 as in the first embodiment, but has a shorter shape as the slit 28 (see FIGS. 3(A), 3(B)) for anchoring the torsion coil spring 14 is omitted.

The present invention has been described in detail based on specific embodiments, but these embodiments are merely illustrations, and the present invention is not to be limited by these embodiments. The shaft support structure according to the present invention is not limited to the above-described cup holder, and can be used for various uses (for example, pipe clamp, lid part of a compartment, hinge part of a glove compartment, and the like), provided that there is at least a shaft support structure for supporting a rotating shaft and there are two members constituted by molded articles. Also, the material of the members is not limited to resin and may be metal, or the like, and the molding process also is not limited to injection molding, and die casting, or the like, can also be applied. Also, it is not the case that all of the constituent elements of the shaft support structure according to the present invention illustrated in the above embodiments are necessary, and the constituent elements can be used selectively within a range not deviating from the scope of the present invention.

### Explanation of the Symbols

1 Cup holder

2 Container-receiving part

3 Holder body

4 Container-holding mechanism

11 Flap (rotating member)

12 Left shaft-bearing member

13 Right shaft-bearing member

14 Torsion coil spring

24 Right rotating shaft

25 Left rotating shaft

26 Rotation-restricting pin (coupling part)

32 Left shaft-bearing opening

36 Right shaft-bearing opening

37 Held part

38 Rotation-restricting hole (corresponding coupling part)

51, 52 Maximum outer perimeter edge part

53, 54 Minimum inner perimeter edge part (corresponding inner perimeter edge part)

C Center of rotation

G Gap

1. A shaft support structure for a rotating member and a shaft-bearing member which are molded articles, the shaft support structure supporting a rotating shaft provided on the rotating member in a pair of shaft-bearing openings provided on the shaft-bearing member,
wherein said rotating shaft has a held part held in at least one of the shaft-bearing openings, said held part having a cross-section of a noncircular shape, and a plurality of maximum outer perimeter edge parts arranged at a maximal distance from a center of rotation and spaced apart from each other in a circumferential direction;
said at least one shaft-bearing opening has a noncircular shape, and a plurality of corresponding inner perimeter edge parts arranged in correspondence with said maximum outer perimeter edge parts; and
a distance from said center of rotation to said maximum outer perimeter edge parts and a distance from said center of rotation to said corresponding inner perimeter edge parts are the same in a state in which said rotating shaft is held in said at least one shaft-bearing opening, and at least one part between said maximum outer perimeter edge parts and said corresponding inner perimeter edge parts is in mutual sliding contact only in a case when said rotating shaft is within a prescribed range of rotation.

2. A shaft support structure according to claim 1, wherein said maximum outer perimeter edge parts and said corresponding inner perimeter edge parts have arc forms having a same curvature as each other.

3. A shaft support structure according to claim 1, wherein each of the maximum outer perimeter edge parts is arranged in symmetrical position based on said center of rotation in a state in which each is spaced apart from each other in the circumferential direction; and
said corresponding inner perimeter edge parts are arranged in plural in correspondence with the positions of said maximum outer perimeter edge parts.

4. A shaft support structure according to claim 1, wherein said rotating shaft has an expanded-diameter part formed adjacent to said held part in an axial direction thereof and at a position toward a side of the other end than the held part, and the expanded-diameter part projects outwardly from said held part than said maximum outer perimeter edge part in a diameter direction.

5. A shaft support structure according to claim 1, wherein said rotating member has a coupling part engageable with said shaft-bearing member; and
said shaft-bearing member has a corresponding coupling part for restricting rotational movement of the rotating member within said prescribed range of rotation by coupling with said coupling part.

6. A shaft support structure according to claim 1, wherein said rotating member and said shaft member are pre-assemblable in a state in which said rotating shaft is held in said at least one shaft-bearing opening.
